(19) United States
(12) Patent Application Publication
(10) Pub. No.: US 2010/0196548 A1
(43) Pub. Date: Aug. 5, 2010

(54) SWEET GOODS PRODUCT

(75) Inventor: Herbert Mederer, Furth (DE)

Correspondence Address: BROWDY AND NEIMARK, P.L.L.C.;624 NINTH STREET, NW, SUITE 300, WASHINGTON, DC, 20001-5303, US

(73) Assignee: Mederer GMBH, Furth (DE)

(21) Appl. No.: 12/667,866

(22) PCT Filed: Jun. 19, 2008
(86) PCT No.: PCT/EP08/04914

§ 371 Date: Jan. 5, 2010

(30) Foreign Application Priority Data
Jul. 5, 2007 (DE) 10 2007 031 369.3

(51) Int. Cl. A23G 3/54; A23G 3/12

(52) U.S. Cl. 426/87; 426/103; 425/448; 426/280

(57) ABSTRACT

Sweet goods product having a base body consisting of a first sweet goods material, which base body exhibits at least one depression, and at least one insert arranged in the at least one depression and consisting of a second sweet goods material and visible from the outside.

The present invention relates to a sweet goods product, a mould for the production thereof and a method for the production thereof.

From DE 203 00 983 U1 there is known a spherical sweet with a core made of a fruit gum mass and a coating made of chocolate.

The invention is based on the object of creating a novel sweet goods product.

Said object is achieved by the features of the independent claims 1, 10 and 14. The core of the invention consists in providing, on the top surface of a bar or tablet of chocolate, depressions, in which inserts made of fruit gum, especially gummy bears, are fixed, which are visible from the outside.

Further advantageous embodiments of the invention result from the subclaims. Additional features and details of the invention result from the description of an embodiment based on the drawings, which show in

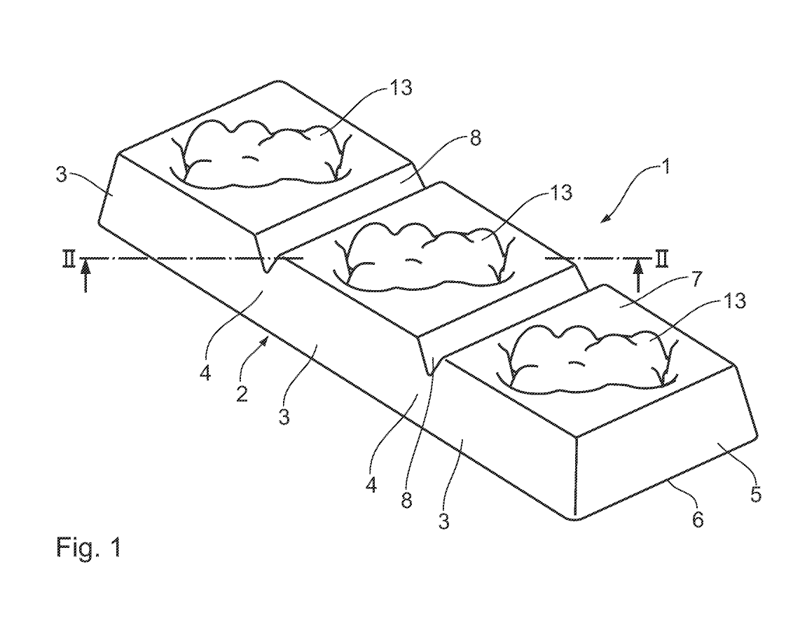

FIG. 1 a perspective view of a sweet goods product,

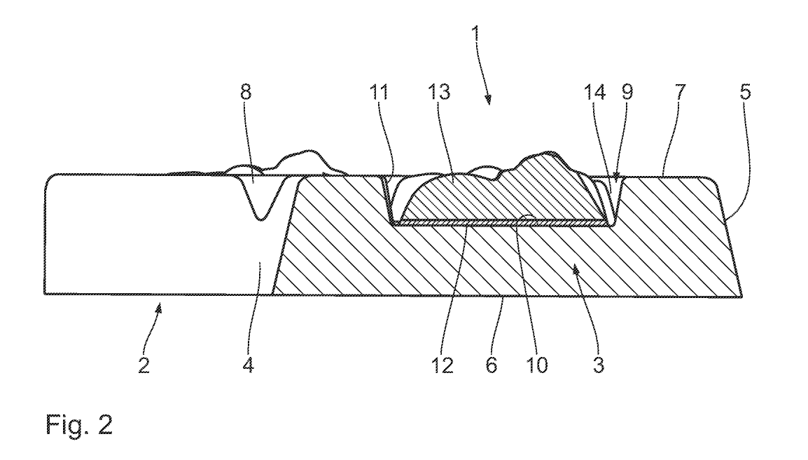

FIG. 2 a sectional view according to line II-II in FIG. 1,

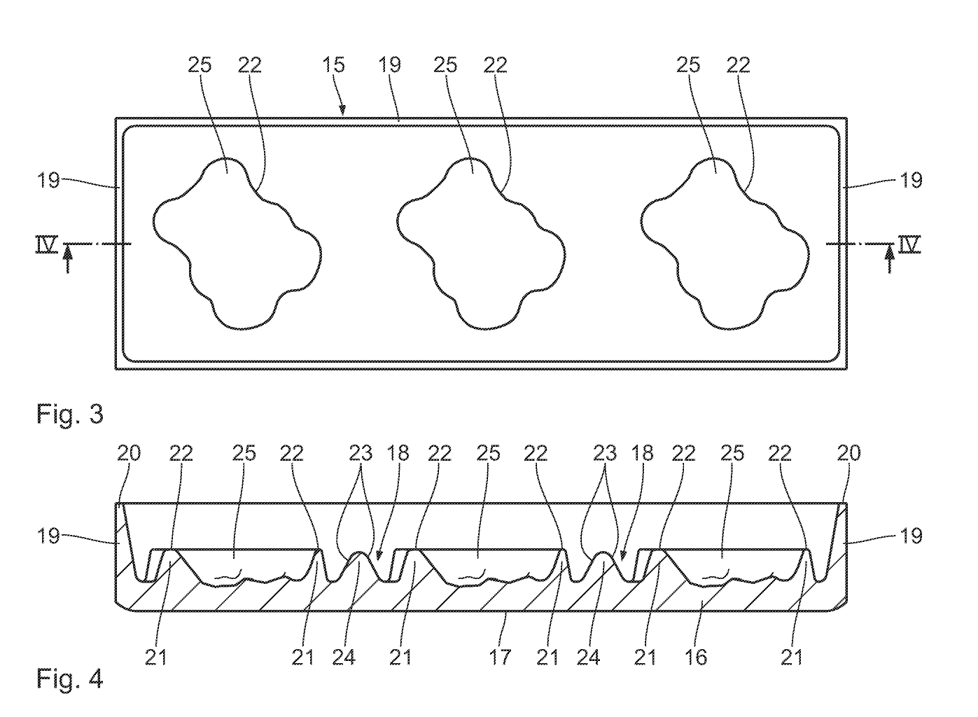

FIG. 3 a top view of a mould for producing the sweet goods product according to FIG. 1,

FIG. 4 a sectional view according to line IV-IV in FIG. 3 and

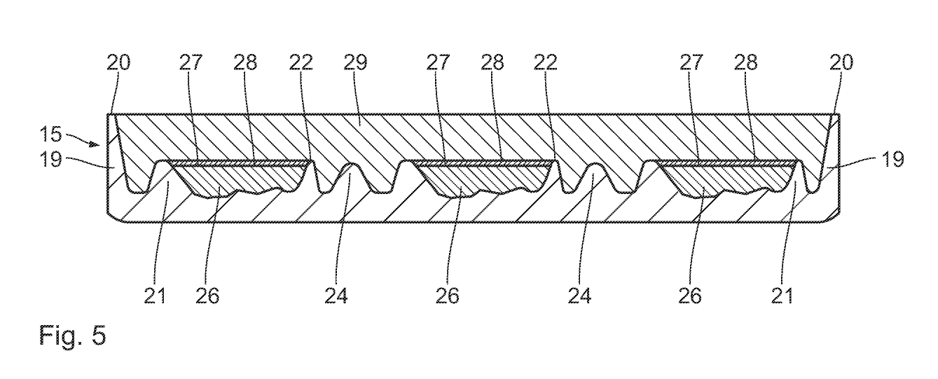

FIG. 5 a sectional view as per FIG. 4 of a filled mould.

In the following there is described with reference to FIGS. 1 and 2 a sweet goods product 1. Said sweet goods product exhibits a base body 2, which has the shape of a chocolate bar consisting of three individual pieces 3, connected with one another via breaking lines 4. It is also possible that the base body 2 has the shape of only one individual piece or that of a tablet of chocolate with individual pieces arranged next to each other in two different directions. On the circumferential side the base body 2 exhibits sloped side planks 5 becoming wider towards the bottom, a bottom side 6 and a top side 7. The breaking lines 4 are formed by trench-like longitudinal depressions 8 in the top side 7. The base body 2 consists of a fat-containing sweet goods material, especially chocolate, especially dark chocolate, plain chocolate, whole milk chocolate or white chocolate. Chocolate-like masses, in which the cocoa butter has been replaced by another vegetable fat, may also be used.

In what is in itself a planar top side 7 there is envisaged in each individual piece 3 a depression 9 having a planar bottom 10. The flanks 11 confining the depression on the circumferential side run slopingly downwards so that the depression 9 has a smaller cross-sectional surface in the area of the bottom 10 than in the area of its upper edge. On the bottom 10 of the depression 9 there is envisaged a thin boundary layer 12 made of a sweet goods material, especially a fat-containing sweet goods material, especially chocolate, especially white chocolate.

On the boundary layer 12 there is arranged an insert 13 consisting of a sweet goods material, especially a fruit gum mass or jelly. In the present case, said material has the shape of a gummy bear, with the front side of the gummy bear protruding outwards with implied feet, arms, ears and a nose. The insert 13 protrudes from the top side 7. It is also possible to design the insert 13 such that its top side is flush with the top side 7 of the individual piece 3. On the circumferential side there is a trench-like depression 14 between the insert 13 and the circumferential flanks 11, so that the insert 13 is connected with the base body 2 only via the boundary layer 12 on its bottom side. Through this type of arrangement, the insert 13 is freely visible from the top and perspectively from the side, which improves the aesthetic effect. The boundary layer 12 has the task of masking the view of the dark chocolate of the base body 2, especially for a light-colour fruit gum mass, so that even light-colour, e.g. yellow gummy bears, are not affected in their colour effect by the brown chocolate. The inserts 13 in the individual pieces 3 are arranged on the relevant diagonal to make better use of the surface area. It is, however, also possible to orientate the inserts 13 differently. Moreover, it is also possible to change the shape of the individual pieces 3 from square to rectangular or even triangular.

In the following there is described with reference to FIGS. 3 and 4 a mould 15 for the production of the sweet goods product 1. The mould 15 exhibits a mould bottom 16 having an essentially rectangular cross-section. Its bottom side 17 is of a planar design. On its top side 18 there is formed the negative shape of the sweet goods product 1. The mould 15 exhibits an outer mould ridge 19 arranged on the outer sides of the mould bottom 16 and protruding upwards, said outer mould ridge having an upper rim 20. The outer mould ridge 19 essentially has in its cross-section a rectangular shape and a closed contour. Within the outer mould ridge 19 there are envisaged several, in the present case three, inner mould ridges 21, also forming a closed contour, each with an upper rim 22. The upper rim 20 protrudes from the lowest point of the mould 15 about twice as high as the inner rims 22. The inner mould ridges 21 confine the negative shape for the relevant insert 13. In the present case this is the negative shape of a gummy bear. Between in each case two neighbouring, closed inner mould ridges 21, there is arranged in each case, protruding upwards from the mould bottom 16 and provided with sloped flanks 23, a barrier 24, which later forms the depression 8 in the sweet goods product. The barriers 24 protrude from the mould bottom 16 about as much as the inner mould ridges 21, possibly a little less. If not bar-shaped sweet goods products, as in FIG. 1, but sweet goods products subdivided like chocolate tablets are to be produced, then the relevant mould not only has barriers running parallel to each other, but a Cartesian raster of barriers. The insert moulds 25 enclosed by the inner ridges 21 are, as already explained with reference to the sweet goods product 1, arranged rotated by 45 ° against the direction of the longitudinal extension of the base body 2.

In the following there is explained with reference to FIG. 5 the production of the sweet goods product 1. The starting point is the empty mould 15, as shown in FIG. 4. Next, at least the surface of the insert moulds 25 is oiled, which can occur by spraying or tampon pressure. Thereafter, a liquid fruit gum mass 26 is filled into insert moulds 25, the top side 27 of the fruit gum mass 26 coming to lie beneath the rim 22, i.e. the relevant insert mould 25 is not fully filled. Onto the top side 27 there is cast a thin layer of white chocolate 28, so that there develops a sticky connection between the fruit gum mass 26 and the white chocolate 28. Thereafter, the mould 15 is filled up to the top rim 20 with dark chocolate 29, especially whole milk chocolate, a sticky connection resulting between the white chocolate 28 and the brown chocolate 29. During the successive casting processes, care is taken to ensure that the mass cast previously has cooled down far enough so that there is no mixing with the layer cast on top, but that the layer underneath is still warm enough for a sticky cast connection to result between the two layers. The inserts 13 are thus firmly connected with the base body 2 via casting connections. Thereafter, the masses 26, 28 and 29 are given sufficient time to solidify before the sweet goods product 1 is removed from the mould 15 and packaged. For practicality reasons it is possible to join a plurality of moulds 15 arranged in a matrix shape to form a large mould.

The resulting sweet goods product 1 combines the allure of chocolate and fruit gum. The visually appealing, shiny nature of the fruit gum shapes is retained, especially thanks to the optical separation layer made of white chocolate.

1-14. (canceled)

15. A sweet goods product having
a. a base body (2) consisting of a first sweet goods material (29), which base body exhibits at least one depression (14), and
b. at least one insert (13), arranged in the at least one depression (14) and consisting of a second sweet goods material (26) and visible from the outside.

16. A sweet goods product according to claim 15, wherein the first sweet goods material (29) is a fat-containing sweet goods material.

17. A sweet goods product according to claim 15, wherein the first sweet goods material (29) is chocolate.

18. A sweet goods product according to claim 15, wherein the first sweet goods material (29) is dark chocolate.

19. A sweet goods product according to claim 15, wherein the second sweet goods material (26) is a fruit gum mass.

20. A sweet goods product according to claim 15, wherein the at least one insert (13) is cast with the base body (2).

21. A sweet goods product according to claim 15, wherein between the first sweet goods material (29) and the second sweet goods material (26) there is arranged a third sweet goods material (28).

22. A sweet goods product according to claim 21, wherein the third sweet goods material (28) is a fat-containing sweet goods material with a lighter colour than the first sweet goods material (29).

23. A sweet goods product according to claim 15, wherein the base body (2) is a bar or tablet having breaking lines (4) to produce individual pieces (3) by breaking them off.

24. A sweet goods product according to claim 15, wherein the at least one insert (13) is a gummy bear.

25. A sweet goods product according to claim 15, wherein the at least one insert (13) lies exposed at least one of towards the top and on its circumferential side.

26. A mould for the production of a sweet goods product according to claim 15 having
a. a mould bottom (16),
b. at least one second mould ridge (21) protruding from the mould bottom (16) and closed alongside its circumference, to limit the accommodation of a second sweet goods materials (26), and
c. at least one first mould ridge (19) protruding from the mould bottom (16) beyond the at least one second mould ridge (21), closed on its circumferential side, to limit the accommodation of a first sweet goods material (29).

27. A mould according to claim 26, wherein a plurality of second mould ridges (21) are arranged next to each other.

28. A mould according to claim 27, wherein between neighbouring second mould ridges (21) there are envisaged barriers (24) protruding from the mould bottom (16) to form breaking lines (4) in the sweet goods product (1).

29. A mould according to claim 26, wherein in each case a second mould ridge (21) confines an insert mould (25) of an insert (13).

30. A mould according to claim 26, wherein the insert (13) is a gummy bear.

31. A method for producing a sweet goods product (1) according to claim 15, comprising the following steps:
providing a mould (15) according to claim 12,
filling a second sweet goods material (26) into the areas enclosed in each case by the second mould ridges (21),
filling a first sweet goods material (29) into the area enclosed by the first mould ridge (19),
allowing the first and the second sweet goods material (29, 26) to solidify, and
removing the created sweet goods product (1) from the mould (15).
